(19) United States
(12) Patent Application Publication
(10) Pub. No.: US 2025/0184590 A1
(43) Pub. Date: Jun. 5, 2025

(54) SWITCHING MECHANISM, ASSEMBLY MECHANISM AND RABBIT CAGE APPARATUS

(71) Applicant: SHENZHEN NEEWER TECHNOLOGY CO. LTD, Shenzhen (CN)

(72) Inventors: Yuling CHEN, Shenzhen (CN); Jiahui MO, Shenzhen (CN); Jun WANG, Shenzhen (CN); Yan KE, Shenzhen (CN)

(73) Assignee: SHENZHEN NEEWER TECHNOLOGY CO. LTD, Shenzhen (CN)

(21) Appl. No.: 18/940,413

(22) Filed: Nov. 7, 2024

(30) Foreign Application Priority Data
Dec. 1, 2023 (CN) 202323305303.8
Jun. 27, 2024 (CN) 202421498463.0

(51) Int. Cl. H04N 23/55; G03B 17/12; G03B 17/56

(52) U.S. Cl. CPC H04N 23/55; G03B 17/12; G03B 17/565; G03B 2217/002

(57) ABSTRACT

Disclosed are a switching mechanism, an assembly mechanism and a rabbit cage apparatus. The switching mechanism applied to being assembled with an assembly mechanism includes: a body provided with a lens hole, the lens hole is configured for mounting a filter, and at least one disassembly structure provided on the body, the disassembly structure includes a sliding portion configured to be detachably and slidably connected to the assembly mechanism.

### CROSS-REFERENCE TO RELATED APPLICATIONS

The present application claims priority to Chinese Patent Application No. 202323305303.8, filed on Dec. 1, 2023, and Chinese Patent Application No. 202421498463.0, filed on Jun. 27, 2024. All of the aforementioned applications are incorporated herein by reference in their entireties.

### TECHNICAL FIELD

The present application relates to the technical field of photographic equipment, and in particular to a switching mechanism, an assembly mechanism and a rabbit cage apparatus.

### BACKGROUND

Using a special filter mounted on a mobile phone camera, special effect photos can be obtained when taking photos with the mobile phone, but the filter cannot be directly mounted on the mobile phone camera on current mobile phones, and some mounting accessories are required. The common method is to equip a mobile phone frame, design a mounting structure at the place corresponding to the mobile phone camera area on the mobile phone frame, and use the switching mechanism as an intermediary medium to detachably select and mount filters with different light filtering effects. That is, the middle part of the switching mechanism is a light through hole. One side of the switching mechanism is detachably mounted on the mounting structure on the mobile phone frame, and the other side of the switching mechanism is detachably mounted on the filter.

The switching mechanism in related art is provided with the circular light through hole as disclosed in US Patent Publication U.S. Pat. No. 11,448,847B2. The switching mechanism is often mounted on the mobile phone frame through threads. When mounted, the switching mechanism threads can be rotated or snapped onto the mounting structure. During this process, when the switching mechanism is rotated, the light through hole is also rotated synchronously. If the light hole is non-circular, such as square or other shapes, the edge of the light through hole may not be directly faced with the camera area of the mobile phone. In some occasions where a strict correspondence between the edge of the light hole and the edge area of the camera is required, rotating to mount the switching mechanism is difficult to meet the requirements.

### SUMMARY

In view of this, the present application provides a new rabbit cage apparatus.

The present application provides a switching mechanism applied to being assembled with an assembly mechanism, and the switching mechanism includes:
a body provided with a lens hole, the lens hole is configured for mounting a filter; and
at least one disassembly structure provided on the body, the disassembly structure includes a sliding portion configured to be detachably and slidably connected to the assembly mechanism.

In an embodiment, the sliding portion is in a concave and convex fit with the assembly mechanism, so as to be detachably and slidably connected to the assembly mechanism.

In an embodiment, sliding portion is provided with a bayonet configured to be clamped with the assembly mechanism.

In an embodiment, the sliding portion includes:
a connection section, one end of the connection section is connected to the body; and
a limit section provided at the other end of the connection section, the connection section, the limit section and the body are enclosed to form the bayonet.

In an embodiment, the switching mechanism further includes:
a soft layer, the soft layer is sandwiched between the switching mechanism and the assembly mechanism after the switching mechanism is assembled with the assembly mechanism.

In an embodiment, the sliding portion includes a first ridge structure extending in a first direction, and the first ridge structure is configured to limit the switching mechanism in a second direction; the first ridge structure is a sliding guide component, and the second direction is intersected with the first direction.

In an embodiment, the first ridge structure is formed with a first guide groove recessed inward.

In an embodiment, disassembly structure is provided with at least one positioning structure, and the positioning structure is cooperated and positioned with the assembly mechanism.

In an embodiment, positioning structure is a positioning member configured to retract and protrude.

In an embodiment, two first ridge structures are respectively formed on edges of opposite sides of the lens hole; a blocking bar is provided between the two first ridge structures, and opposite ends of the blocking bar are correspondingly connected to the two first ridge structures, so that a slide entrance is formed at an end of the first ridge structure opposite to the blocking bar.

The present application also provides an assembly mechanism applied to mounting a switching mechanism, including:

a mounting member provided with an avoidance hole, an area of the mounting member without the avoidance hole is provided with a cooperation portion cooperated and limited with the sliding portion of the switching mechanism.

In an embodiment, the cooperation portion is in a concave and convex fit with the switching mechanism, so as to be detachably and slidably connected to the switching mechanism.

In an embodiment, the mounting member is provided with an assembly chamber with an opening, and the assembly chamber is configured to slidably cooperate with the sliding portion of the switching mechanism; an extension section is provided at an edge of the assembly chamber, and the extension section is configured to be snapped into the bayonet of the switching mechanism.

In an embodiment, the assembly chamber includes a pre-positioning chamber and a clamping chamber communicated with the pre-positioning chamber; the extension section is provided at a top of the clamping chamber, and the opening is provided at a top of the pre-positioning chamber and communicated with the pre-positioning chamber.

In an embodiment, the assembly mechanism further includes:

a positioning component configured to position the switching mechanism.

In an embodiment, the assembly mechanism further includes:
a positioning component, the mounting member is provided with an accommodation groove, and the positioning component includes:
an elastic member provided in the accommodation groove; and
a positioning member, the elastic member is configured to drive the positioning member to elastically abut against the switching mechanism.

In an embodiment, the cooperation portion includes a second ridge structure provided on at least one side of the avoidance hole and extended in a first direction; the second ridge structure is configured to limit the switching mechanism in a second direction, so that the switching mechanism is configured to slide along the first direction.

In an embodiment, a second guide groove recessed inward is provided on a side of the second ridge structure away from the avoidance hole, and an extending direction of the second guide groove is consistent with an extending direction of the second ridge structure.

In an embodiment, the assembly mechanism further includes:
a soft layer, the soft layer is sandwiched between the switching mechanism and the assembly mechanism after the switching mechanism is assembled with the assembly mechanism.

The present application provides a rabbit cage apparatus, including:
a cage frame;
an assembly mechanism provided at the cage frame;
a switching mechanism detachably assembled with the assembly mechanism through a disassembly structure; and
a soft layer;
the soft layer is sandwiched between the switching mechanism and the assembly mechanism after the assembly mechanism is assembled with the switching mechanism.

The beneficial effect is that the disassembly structure includes the sliding portion configured for detachably and slidably connecting the assembly mechanism, so that the switching mechanism can be assembled or disassembled with the assembly mechanism by sliding, thereby improving the assembly accuracy and assembly stability of the switching mechanism.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a schematic structural view of a switching mechanism according to an embodiment of the present application.

FIG. 2 is a schematic view of a working principle of the switching mechanism of the present application.

FIG. 3 is a schematic view of a working principle of the switching mechanism of the present application.

FIG. 4 is a schematic view of a working principle of the switching mechanism of the present application.

FIG. 5 is a schematic structural view of a back side of the switching mechanism according to the embodiment in FIG. 1.

FIG. 6 is a schematic structural view of a mounting member structure of the assembly mechanism of the present application.

FIG. 7 is a schematic structural view of the rabbit cage apparatus of the present application in using state.

FIG. 8 is a schematic exploded structural view of a rabbit cage apparatus of the present application.

FIG. 9 is a schematic structural view of a pre-assembly operation of the rabbit cage apparatus of the present application.

FIG. 10 is a schematic cross-sectional structural view along E-E of the embodiment in FIG. 9.

FIG. 11 is a schematic partially enlarged structural view at Q in FIG. 10.

FIG. 12 is a schematic structural view of an assembled rabbit cage apparatus of the present application.

FIG. 13 is a schematic cross-sectional structural view along F-F of the embodiment in FIG. 12.

FIG. 14 is a schematic partially enlarged structural view at M in FIG. 13.

FIG. 15 is a schematic structural view of the rabbit cage apparatus of the present application in using state.

FIG. 16 is a schematic structural view of the switching mechanism structure of the embodiment in FIG. 12.

FIG. 17 is a schematic three-dimensional structural view of the switching mechanism according to an embodiment of the present application.

FIG. 18 is a schematic enlarged structural view at Z in FIG. 17.

FIG. 19 is a schematic three-dimensional structural view of the switching mechanism according to an embodiment of the present application.

FIG. 20 is a schematic three-dimensional structural view of the switching mechanism according to an embodiment of the present application.

FIG. 21 is a schematic enlarged structural view at N in FIG. 20.

FIG. 22 is a schematic exploded structural view of the rabbit cage apparatus according to an embodiment of the present application.

FIG. 23 is a schematic three-dimensional structural view of the rabbit cage apparatus according to an embodiment of the present application.

FIG. 24 is a schematic exploded structural view of the rabbit cage apparatus according to an embodiment of the present application.

FIG. 25 is a schematic cross-sectional structural view of the rabbit cage apparatus according to an embodiment of the present application.

FIG. 26 is a schematic cross-sectional structural view of the rabbit cage apparatus according to an embodiment of the present application.

FIG. 27 is a schematic structural view of the switching assembly according to an embodiment of the present application.

### DETAILED DESCRIPTION OF THE EMBODIMENTS

With reference to FIG. 1 to FIG. 26, embodiments of the present application are described as followed.

Based on the above ideas and problems, the present application provides a switching mechanism 100, an assembly mechanism 300 cooperated with the switching mechanism 100, and a rabbit cage apparatus 500 mounted with the switching mechanism 100 and the assembly mechanism 300.

It should be noted that the rabbit cage of the rabbit cage apparatus 500 of the present application can be a mobile phone rabbit cage, a mobile phone protective shell, or a camera rabbit cage. Taking the mobile phone rabbit cage as an example, the mobile phone rabbit cage is called as iout Koziro. The mobile phone rabbit cage component can be used as a mobile phone holder, and other accessories can also be added to the mobile phone holder. The outer periphery of the mobile phone holder can also be provided with at least one handle, which can be a wooden handle for easy grasping and use.

Referring to FIG. 1 to FIG. 8, the switching mechanism 100 is configured to be detachably mounted on the assembly mechanism 300, and the assembly mechanism 300 is mounted on or formed on the cage frame 50 to form the rabbit cage apparatus 500.

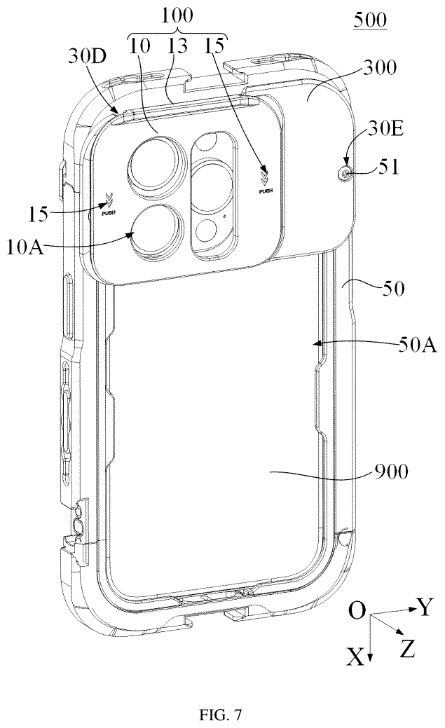

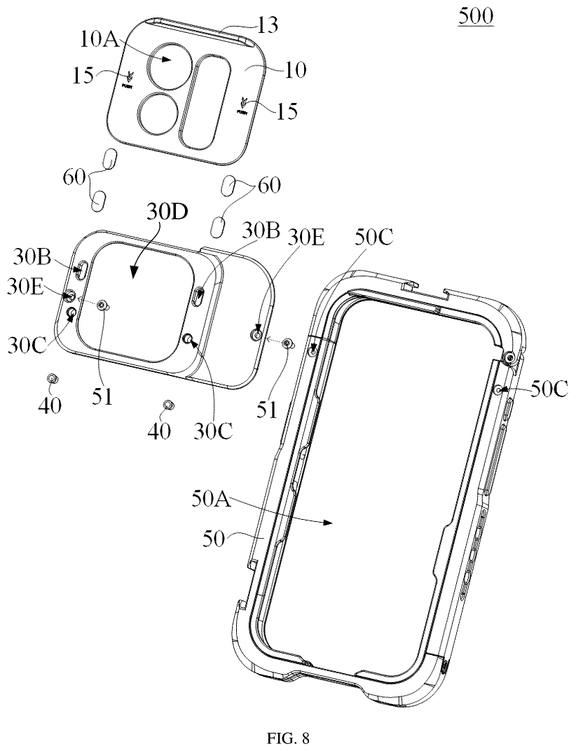

For the rabbit cage apparatus 500, referring to FIG. 7 and FIG. 8, the rabbit cage apparatus 500 includes a cage frame 50 and an assembly mechanism 300 provided on the cage frame 50. The cage frame 50 is provided with an accommodation chamber 50A for accommodating the shooting terminal 900. The assembly mechanism 300 is at a position of the cage frame 50 directly faced with the lens module of the shooting terminal 900, and the assembly mechanism 300 is provided with an avoidance hole 30D corresponding to the lens module. The switching mechanism 100 is detachably mounted on the assembly mechanism 300, and different filters are detachably replaced and mounted on the switching mechanism 100, so that different types of filters can be mounted on the rabbit cage apparatus 500, and different mobile phone shooting effects can be obtained when shooting.

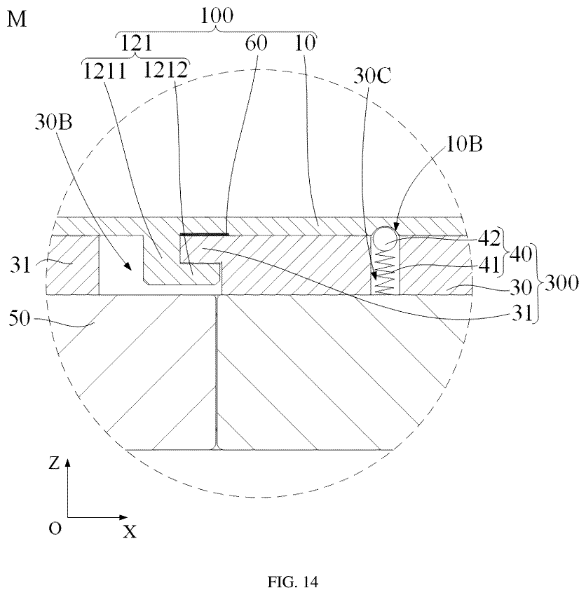

As shown in FIG. 1 and FIG. 14, according to an embodiment of the present application, a switching mechanism 100 is provided, which is applied to being assembled with the assembly mechanism 300. The switching mechanism 100 includes a body 10 and at least one disassembly structure 12, and the body 10 is provided with at least one lens hole 10A configured for mounting a filter or an area where a filter is mounted. At least one disassembly structure 12 is provided on the body 10; the disassembly structure 12 includes a sliding portion 121, and the sliding portion 121 is configured for detachably and slidably connecting the assembly mechanism 300.

Different from the mounting method of the assembly mechanism 300 and the switching mechanism 100 in which the rotation connection is made, the switching mechanism 100 of the present application is slidably mounted with the assembly mechanism 300. When the switching mechanism 100 slides to the preset position and can be aligned with the area of the avoidance hole 30D, it is more convenient to align the lens hole 10A of the switching mechanism 100 with the camera modular of the phone accommodated in the accommodating chamber 50A.

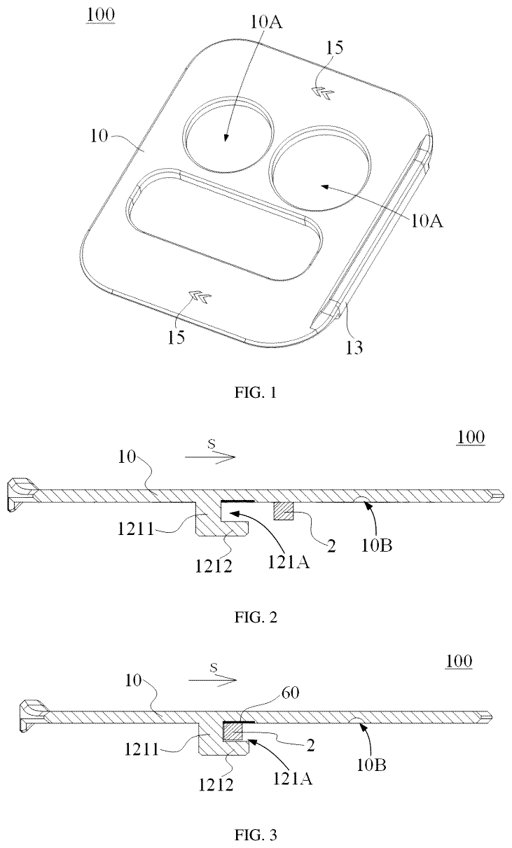

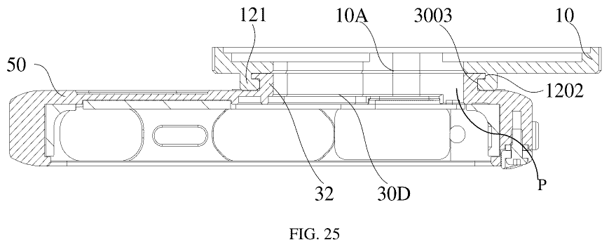

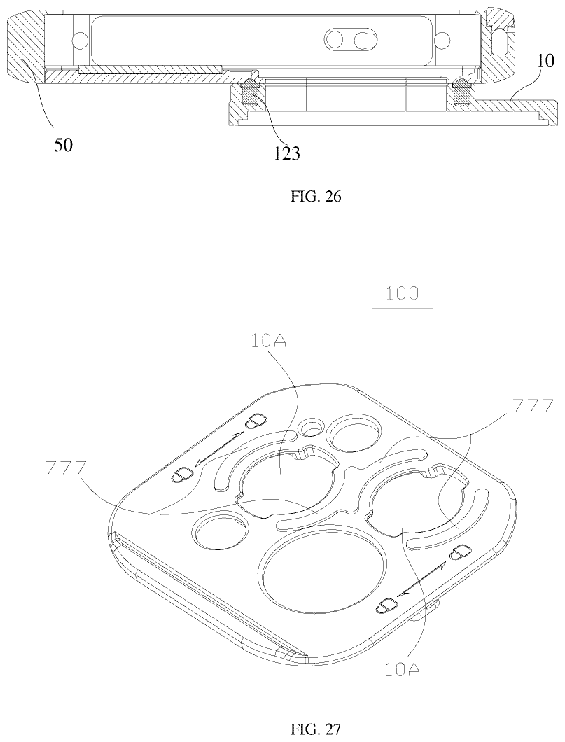

In an embodiment, as shown in FIG. 2, FIG. 25 and FIG. 26, the sliding portion 121 is provided with a concave portion and/or a convex portion to achieve a detachable and slidable connection with the assembly mechanism 300 through a concave-convex fit.

The concave portion and/or the convex portion are provided in the sliding portion 121, so that the sliding portion 121 and the assembly structure form a sliding connection structure in a concave-convex fit, which is more convenient to limit the switching mechanism 100 during the mounting process, so as to improve the assembly efficiency and accuracy. The positioning of the concave-convex fit can be a cooperation between a dovetail groove and a dovetail slide plate, a cooperation between the slide groove 1201 and the sliding bar or a sliding stripe, a sliding cooperation between the slide groove 1201 and the sidewall in the thickness direction of the body 10, an inverted “T” shape cross-section concave-convex fit, or a cooperation between the protruding sliding portion 121 inserted into the assembly chamber 30B, etc.

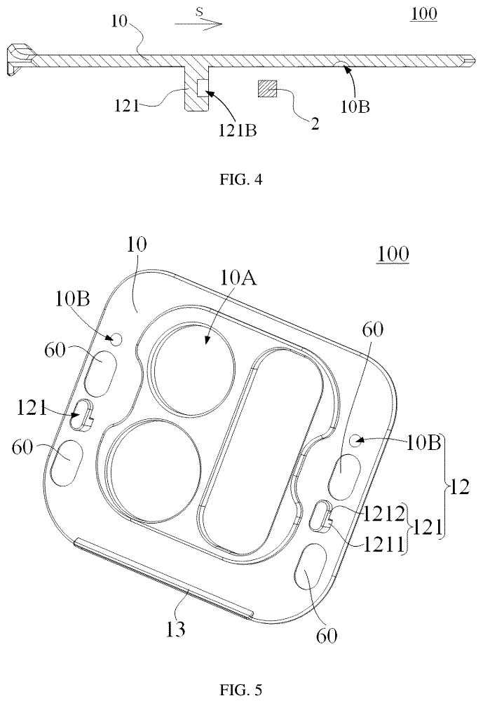

In an embodiment, as shown in FIG. 2, FIG. 3 and FIG. 4, the sliding portion 121 is provided with a bayonet 121A configured to snap into the assembly mechanism 300.

The sliding portion 121 is provided with the bayonet 121A. When the sliding portion 121 slides on the assembly mechanism 300 and contacts the sidewall 2 of the assembly mechanism 300, due to the facing setting of the sidewall 2, the bayonet 121A is snapped into the sidewall 2 of the assembly mechanism 300 and is fixed by the frictional force between the bayonet 121A and the sidewall 2.

Referring to FIG. 2, when the switching mechanism 100 is mounted on the assembly mechanism 300, the switching mechanism 100 slides on the assembly mechanism 300 along the S direction. The bayonet 121A is faced with the sidewall 2 of the assembly mechanism 300. As shown in FIG. 3, when the switching mechanism 100 slides to the position where the bayonet 121A contacts the sidewall 2, the bayonet 121A is snapped into the sidewall 2, so that the switching mechanism 100 is slidably connected to the assembly mechanism 300.

In an embodiment, as shown in FIG. 2 and FIG. 3, the sliding portion 121 includes a connection section 1211 and a limit section 1212. One end of the connection section 1211 is connected to the body 10, the limit section 1212 is provided at the other end of the connection section 1211, and the connection section 1211, the limit section 1212 and the body 10 are enclosed to form the bayonet 121A.

The connection section 1211 and the limit section 1212 are L-shaped, and the bayonet 121A is faced with the position of the sidewall 2 of the assembly mechanism 300. The bayonet 121A is formed by the structure of the sliding portion 121 and the structure of the body 10.

The extending direction of the limit section 1212 is parallel to the sliding direction, and is provided at an angle with the connection section 1211.

In this embodiment, the body 10 of the switching mechanism 100 is plate-shaped, the lens hole 10A is opened on the body 10, and the sliding portion 121 is provided on the back of the body 10 and distributed on both sides of the lens hole 10A to be opposite to each other, so that the filter covers the former camera and realizes the replacement of different filters.

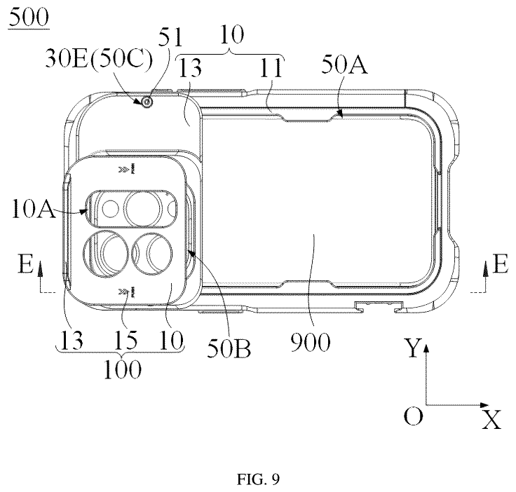

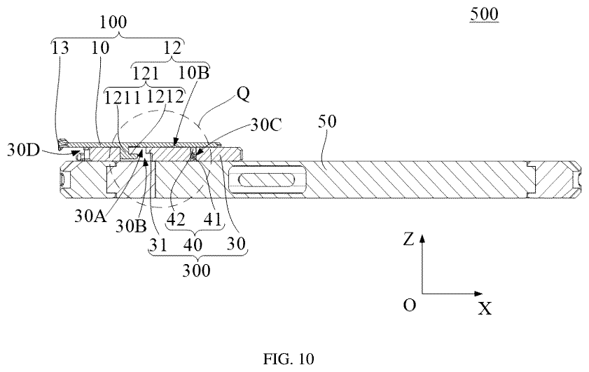

Referring to FIG. 9, the back of the body 10 is attached to the assembly mechanism 300 along the O-XY plane and slides relative to the assembly mechanism 300 along the first direction X to be assembled. As shown in FIG. 5 and FIG. 7, the connection section 1211 is provided on the back of the body 10 and extends along the third direction Z. One end of the connection section 1211 is connected to the body 10. When assembling, the other end of the connection section 1211 extends into the assembly chamber 30B through the opening 30A along the third direction Z. The limit section 1212 extends along the first direction X and is perpendicular to the connection section 1211. When it needs to couple the switching mechanism 100 to the assembly mechanism 300, after inserting the connection section 1211 into the assembly chamber 30B, the body 10 slides along the S direction in the assembly chamber 30B along the sliding direction and finally contacts the sidewall 2 and is snapped in the sidewall 2.

As shown in FIG. 9 to FIG. 11, in the pre-assembly stage, the connection section 1211 and the limit section 1212 are inserted into the pre-positioning chamber 301B of the assembly chamber 30B through the opening 30A along the third direction, that is, the Z direction, and the relative position of the switching mechanism 100 and the assembly mechanism 300 is pre-positioned. After pre-positioning, the switching mechanism 100 is pushed relative to the assembly mechanism 300 along the first direction, that is, the X direction, so as to push the limit section 1212 into the clamping chamber 302B, that is, the section or an edge of the opening 30A, such as an extension section 31 is inserted into the connection section 1211, and the limit section 1212 and the body 10 are enclosed to form the bayonet 121A.

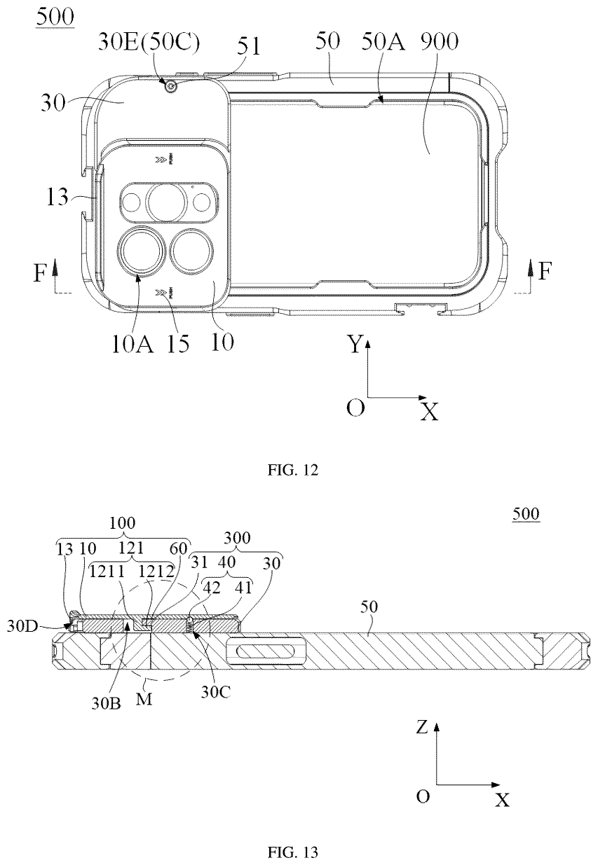

As shown in FIG. 12 to FIG. 14, after the assembly is completed, the sliding portion 121 is limited in the assembly chamber 30B as a whole, and the positioning component 40 is limited in the positioning groove 10B. The limit section 1212 is circumferentially limited along the second direction Y and the third direction Z by the clamping chamber 302B and the extension section 31, and the positioning component 40 is cooperated with the positioning groove 10B to limit the relative displacement of the switching mechanism 100 and the assembly mechanism 300 along the first direction X, thereby improving the assembly reliability of the assembly mechanism 300 and the switching mechanism 100.

In an embodiment, the sliding portion 121 is in a straight strip shape, and the bayonet 121A can also be a notch 121B recessed on the sliding portion 121 and spaced apart from the body 10. As shown in FIG. 4, the bayonet 121A is the notch 121B recessed on the sliding portion 121, and the notch 121B is directly faced with the sidewall 2 of the assembly mechanism 300. When the sliding portion 121 slides on the assembly mechanism 300 and contacts the sidewall 2 of the assembly mechanism 300, the notch 121B is engaged with the sidewall 2 of the assembly mechanism 300, so that the switching mechanism 100 is connected to the assembly mechanism 300.

In an embodiment, the disassembly structure 12 is provided with at least one positioning structure 123 or positioning component 40 configured to be coordinated with the assembly mechanism 300 for positioning.

In this embodiment, one side of the body 10 is the first assembly surface 10D, the disassembly structure 12 can be provided on the first assembly surface 10D, and the positioning structure 123 can also be provided on the first assembly surface 10D. The switching mechanism 100 moves along the first direction X under the limit of the sliding portion 121. When the switching mechanism 100 moves to the preset position, the switching mechanism 100 can be locked by the positioning structure 123, which can prevent the switching mechanism 100 from moving to the preset position along the first direction X and moving in the reverse direction to loosen and fall off, so as to facilitate the mounting of the switching mechanism 100.

In an embodiment, as shown in FIG. 5 and FIG. 26, the positioning structure 123 is the positioning groove 10B, or the positioning structure 123 is the positioning member 42, and the positioning member 42 can be retracted and protruded.

In this embodiment, the positioning groove 10B is configured to be cooperated with the assembly mechanism 300 to limit the body 10, and the positioning member 42 can be retracted and protruded from the first assembly surface 10D. When the positioning structure 123 of the body is the positioning groove 10B, the assembly mechanism 300 is provided with the positioning component 40 corresponding to the positioning groove 10B. When the positioning structure 123 of the body 10 is the positioning component 40, the assembly mechanism 300 is provided with the positioning groove 10B corresponding to the positioning component 40 of the body 10. The positioning groove 10B and the positioning component 40 described above can be cooperated to position.

When the positioning structure 123 on the body 10 is the positioning groove, the assembly mechanism 300 is provided with an accommodation groove 30C facing the switching mechanism 100, and the positioning component 40 is provided in the accommodation groove 30C. Referring to FIG. 7 to FIG. 14, after the sliding portion 121 is inserted from the opening 30A into the assembly chamber 30B along the third direction Z, the sliding portion 121 is limited along the second direction Y, and the sliding portion 121 can slide to the preset position or the limit position along the first direction X, and one end of the sliding portion 121 is snapped in the assembly chamber 30B, so that the sliding portion 121 is limited along the second direction Y and the third direction Z at the same time, and the sliding portion 121 will not return in the reverse direction along the first direction X without external force. When the sliding portion 121 slides to the preset position or the limit position, the positioning groove 10B of the switching mechanism 100 is directly faced with the accommodation groove 30C of the assembly mechanism 300, and one end of the positioning component 40 provided at the opening of the accommodation groove 30C elastically extends and pushes into the positioning groove 10B, so as to further limit the switching mechanism 100 along the first direction, that is, the X direction, improve the stability of setting the sliding portion 121 in the assembly chamber 30B, and improve the reliability of the limit of the switching mechanism 100 to the assembly mechanism 300.

It can be understood that the accommodation groove 30C is opened on the assembly mechanism 300 along the third direction, that is, the Z direction, and the rabbet of the accommodation groove 30C is opened towards one side of the switching mechanism 100. When the switching mechanism 100 and the assembly mechanism 300 are not assembled, one end of the positioning component 40 is relatively restricted to the bottom wall or the sidewall of the accommodation groove 30C, and the other end of the positioning component 40 extends towards the rabbet along the third direction, that is, the Z direction.

In the natural state, one end of the positioning component 40 is fixed in the accommodation groove 30C, and the other end is a free end, which passes over the rabbet.

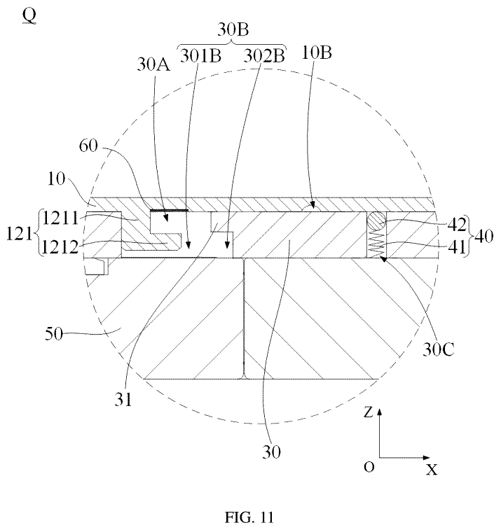

With reference to FIG. 10 and FIG. 11, when the switching mechanism 100 slides relative to the assembly mechanism 300 along the first direction X, the switching mechanism 100 is closely attached to the upper plane of the assembly mechanism 300, so that the positioning component 40 is pressed downward by the switching mechanism 100, the free end of the positioning component 40 is pressed downward along the third direction Z and retracted into the accommodation groove 30C, and the positioning component 40 is in a compressed state. With reference to FIG. 13 and FIG. 14, after the sliding portion 121 slides to the preset position or the limit position along the first direction X, the positioning groove 10B is directly faced with the accommodation groove 30C, so that the free end of the positioning component 40 pops out along the third direction Z and is inserted into the positioning groove 10B, so as to limit the sliding direction of the switching mechanism 100 and the assembly mechanism 300 along the first direction X, thereby improving the assembly stability of the switching mechanism 100 and the assembly mechanism 300.

In an embodiment, the switching mechanism 100 includes two disassembly structures 12 spaced apart and provided on both sides of the lens hole 10A.

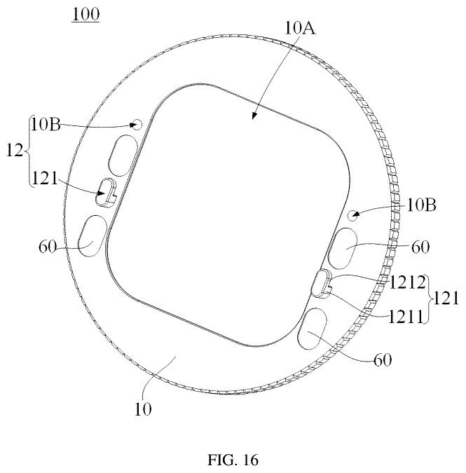

In an embodiment, with reference to FIG. 5, FIG. 12 and FIG. 16, the disassembly structure 12 includes a sliding portion 121 and a positioning groove 10B, and the sliding portion 121 and the positioning groove 10B are spaced apart and provided on the body 10 along the first direction, that is, the X direction. Both the sliding portion 121 and the positioning groove 10B can be provided on the same side of the lens hole 10A, or can be provided on both sides of the lens hole 10A, the sliding portion 121 is configured to perform a sliding assembly limit with the assembly chamber 30B, and the positioning groove 10B is configured to cooperate with the positioning component 40 of the assembly mechanism 300 to perform a limit in the O-XY plane.

In an embodiment, one or more disassembly structure 12 can be provided. As shown in FIG. 16, for example, two disassembly structures 12 are provided, and the two disassembly structures 12 are distributed on both sides of the lens hole 10A, so that two sliding portions 121 are provided on opposite sides of the lens hole 10A, and the two positioning grooves 10B are also provided on opposite sides of the lens hole 10A. The connecting line of the two sliding portions 121 is parallel to the second direction, that is, the Y direction, or the connecting line of a sliding portion 121 and a positioning groove 10B is parallel to the second direction, that is, the Y direction. One end of each sliding portion 121 away from the body 10 is extended in the same direction along the first direction, that is, the X direction, so that the opposite sides of the lens hole 10A on the switching mechanism 100 are detachably assembled with the assembly chamber 30B on both sides of the assembly mechanism 300 respectively, so as to improve the assembly balance and stability.

The switching mechanism 100 is provided with at least one sliding portion 121 adjacent to the positioning groove 10B. The number of the assembly chambers 30B on the switching mechanism 300 corresponds to the number of sliding portions 121. At least one sliding portion 121 and the positioning groove 10B are spaced on the same side of the lens hole 10A. In an embodiment, each disassembly structure 12 includes two sliding portions 121 spaced apart on both sides of the positioning groove 10B.

In this embodiment, each disassembly structure 12 may include at least two sliding portions 121, and the assembly mechanism 300 is provided with an assembly chamber 30B corresponding to a sliding portion 121. The two sliding portions 121 are provided along the first direction X, and the two sliding portions 121 are spaced apart on both sides of the positioning groove 10B, so that the same side of the lens hole 10A is detachably assembled with the assembly chamber 30B through the two sliding portions 121.

In an embodiment, each disassembly structure 12 includes two positioning grooves 10B spaced apart on both sides of the sliding portion 121.

In this embodiment, one or more disassembly structures 12 can be provided on the switching mechanism 100. For example, the two disassembly structures 12 are provided on both sides of the lens hole 10A along the second direction Y to detachably assemble the two sides of the body 10 of the switching mechanism 100 with the assembly mechanism 300.

In an embodiment, the switching mechanism 100 may be provided with a sliding portion 121 and a positioning groove 10B at the same side of the lens hole 10A, or a combination of a sliding portion 121 and two positioning grooves 10B. When two positioning grooves 10B are provided, the two positioning grooves 10B are respectively provided on both sides of the sliding portion 121 along the first direction X. The switching mechanism 100 performs two-point positioning of the body 10 along the sliding direction through the two positioning grooves 10B, which can prevent the switching mechanism 100 from being skewed, so that the filter is accurately set and remains stationary relative to the lens module, thereby improving the image quality of the filter.

As shown in FIG. 1 to FIG. 10 and FIG. 12 to FIG. 13, in an embodiment, a blocking plate 13 is provided on one side of the body 10. When the switching mechanism 100 slides along the assembly chamber 30B to the preset position or the limit position, the blocking plate 13 abuts against the outer edge of the limit at the assembly mechanism 300.

In this embodiment, as shown in FIG. 10, the length direction of the blocking plate 13 extends along the second direction, that is, the Y direction; the height direction of the blocking plate 13 extends along the third direction, that is, the Z direction, and protrudes towards the side of the body 10 facing the assembly mechanism 300. The blocking plate 13 is provided at one side edge of the body 10. When the assembly is completed, the blocking plate 13 is snapped on the outer edge of the body 10, so that the assembly sliding of the switching mechanism 100 along the first direction, that is, the X direction is limited, and the switching mechanism 300 is further prevented from sliding excessively.

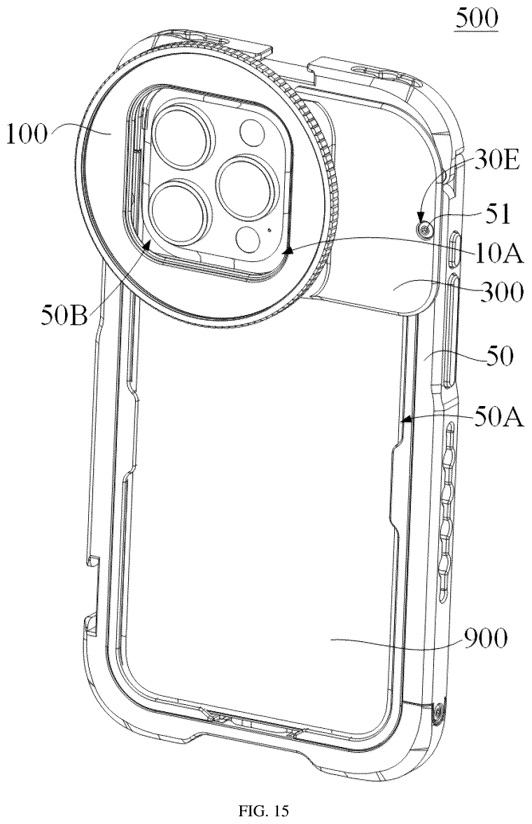

With reference to FIG. 1, FIG. 7, FIG. 15 and FIG. 16, in an embodiment, the switching mechanism 100 is circular, or the switching mechanism 100 is rectangular.

In an embodiment, a fool-proof structure 15 is provided on one side of the body 10 facing away from the disassembly structure 12, and the fool-proof structure 15 is configured for fool-proof assembly.

In this embodiment, the fool-proof structure 15 can be a printed fool-proof mark, or a ridge protruding from the surface of the side of the switching mechanism 100 facing away from the assembly mechanism 300. The fool-proof structure 15 can be a symbol, such as an arrow, or a text indication, or a combination of text and symbols, so as to intuitively determine the assembly orientation of the switching mechanism 100 and the assembly mechanism 300, improve assembly efficiency, and reduce assembly errors.

In other embodiments, in addition to the assembly along the X direction described above, the switching mechanism 100 and the assembly mechanism 300 can also be designed to be assembled along the second direction, that is, the Y direction. The assembly chamber 30B can be designed to run along the second direction, that is, the Y direction, and the corresponding structure and orientation are adjusted accordingly, which will not be described here. The first direction X, the second direction Y, and the third direction Z only assist in identifying the orientation, and do not limit the structural setting orientation and assembly orientation of the rabbit cage apparatus 500.

In an equivalent embodiment, the location of the assembly chamber 30B on the assembly mechanism 300 and the location of the disassembly structure 12 on the switching mechanism 100 can be exchanged, that is, the assembly chamber 30B can be provided on the switching mechanism 100, and the disassembly structure 12 can be provided on the assembly mechanism 300.

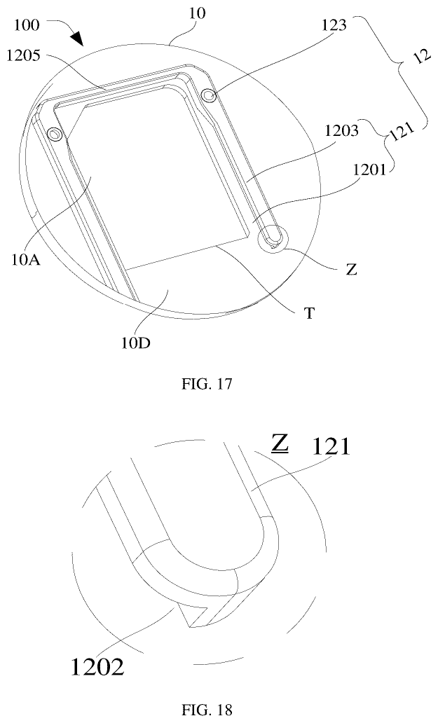

In other embodiments, the sliding connection between the switching mechanism 100 and the assembly mechanism 300 may also be a concave-convex fit sliding connection, as shown in FIG. 17 and FIG. 20, the sliding portion 121 may include a first ridge structure 1203 extending in the first direction X. The first ridge structure 1203 limits the switching mechanism 100 in the second direction Y, and the first ridge structure 1203 is a sliding guide component, which may be a sliding block or a sliding stripe, and the second direction Y is intersected with the first direction X. In an embodiment, the sliding portion 121 may also be a slide groove 1201 extending in the first direction X.

In this embodiment, a first assembly surface 10D is formed on one side of the body 10 where the sliding portion 121 is provided, and the sliding portion 121 is at a certain distance from the edge of the lens hole 10A on the corresponding side, so that the slide groove 1201 is formed between the sliding portion 121 and the first assembly surface 10D. The groove wall of the slide groove 1201 is the sidewall of the first assembly surface 10D and the sliding portion 121, and the sliding portion 121 is formed with a guide and a limit, so as to form the concave-convex fit sliding structure.

In an embodiment, as shown in FIG. 18, the first ridge structure 1203 is formed with a first guide groove 1202 recessed inwardly. In an embodiment, the first guide groove 1202 can also be recessed outwardly, as depicted above, the groove can also be inverted-T shape cross-section groove, etc.

In this embodiment, the first ridge structure 1203 can be formed with a slide groove 1201 to slide with the second ridge structure 321. The extending direction of the first guide groove 1202 is consistent with the extending direction of the slide groove 1201. The first guide groove 1202 allows the sliding portion 121 and the second ridge structure 321 to form two sets of sliding structures in the concave-convex fit, and the sliding process is smoother.

In an embodiment, the body 10 is also provided with a connection port 10C configured for connecting a filter, and the filter can be connected to the connection port 10C through threads or magnetic attraction to cover the lens hole 10A. The connection port 10C and the lens hole 10A are respectively provided on the front and back sides of the body 10, or the connection port 10C is provided on the hole wall of the lens hole 10A.

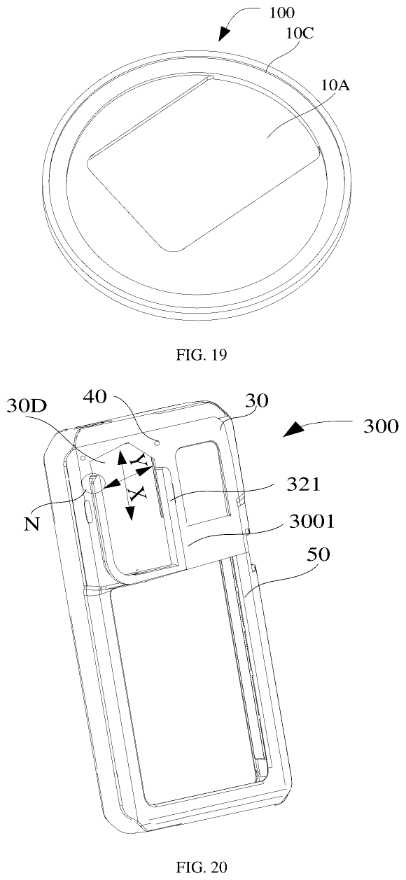

In an embodiment, as shown in FIG. 19, in some embodiments, the lens hole 10A is a square hole, and the body 10 has two sides. The connection port 10C of the annular structure is provided on the edge of the front side, and the sliding portion 121 is provided around the lens hole 10A on the back side, so that the sliding portion 121 and the connection port 10C are respectively arranged on the front and back sides of the body 10. Of course, the lens hole 10A can also be a circular hole or a hole of other shapes, which is not specifically limited here. The connection port 10C is around the lens hole 10A.

In an embodiment, as shown in FIG. 8, the lens hole 10A is a circular hole, and the hole wall of the lens hole 10A serves as the connection port 10C.

The filter is connected to the connection port 10C by threads or magnetic adsorption.

The connection port 10C can be threads or a magnetic adsorption structure, or a magnetic material or magnet can be provided in the switching mechanism to attach to the filter with a magnet or magnetic material.

If the filter is connected to the switching mechanism 100 by threads, the filter can be easily rotated and adjusted.

If the filter is connected to the switching mechanism 100 by magnetic adsorption, the filter and the switching mechanism 100 can be quickly mounted and disassembled, and the mounting is stable and reliable. At the same time, the filter is very flexible and convenient when sliding up and down or rotating left and right.

A magnetic material laying area can be provided at the connection port 10C, and a magnetic adsorption structure that can generate magnetic adsorption can be provided at the connection part of the filter. The magnetic material usually refers to the material that can directly generate magnetism, such as magnets, rubber magnets or metal magnets. The permanent magnetic material can be adopted to ensure long-term and reliable use. The magnetic adsorption structure that can be magnetically attracted to magnetic materials can include parts made of magnetic materials, non-magnetic ferrous materials and a combination of the two. The non-magnetic ferrous materials usually refer to materials containing more than 40% iron elements, such as stainless iron, steel, and iron plates.

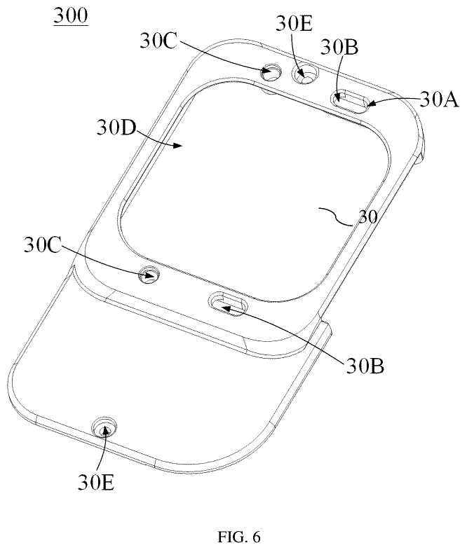

As shown in FIG. 6 and FIG. 20, the present application further provides an assembly mechanism 300. The switching mechanism 100 is detachably mounted on the assembly mechanism 300 through a sliding connection. The assembly mechanism 300 includes a mounting member 30 provided with an avoidance hole 30D, and the area of the mounting member 30 without the avoidance hole 30D is provided with a cooperation portion 32 that matches the sliding portion 121 of the switching mechanism 100. When the switching mechanism 100 is mounted on the assembly mechanism 300, the avoidance hole 30D on the assembly mechanism 300 is directly faced with and is at least partially overlapped with the lens hole 10A of the switching mechanism 100.

In this embodiment, the cooperation portion 32 is provided on the assembly structure, and the cooperation portion 32 matches the sliding portion 121 of the switching mechanism 100 to limit, so that the switching mechanism 100 is detachably and slidably connected to the assembly mechanism 300.

In an embodiment, the cooperation portion 32 is a concave portion and/or a convex portion of the guide member, so as to be in a concave-convex fit with the guide portion of the switching mechanism 100 and realize a detachable and sliding connection. The cooperation portion 32 is provided with a concave portion and/or a convex portion, so that the sliding portion 121 and the cooperation portion 32 can form a sliding connection structure in the concave-convex fit, which is more convenient for limiting the switching mechanism 100 during mounting, so as to improve the assembly efficiency and accuracy.

In an embodiment, the mounting member 30 is provided with an assembly chamber 30B having an opening 30A, and the assembly chamber 30B is configured for slidably matching the sliding portion 121 of the switching mechanism 100. The edge of the assembly chamber 30B is provided with an extension section 31 configured to be inserted into the bayonet 121A of the switching mechanism 100.

In this embodiment, the cooperation portion 32 includes an assembly chamber 30B having an opening 30A and an extension section 31 provided in the assembly chamber 30B. The extension section 31 protrudes in the assembly chamber 30B along the X direction. The sliding portion 121 can be inserted into the assembly chamber 30B and slide in the X direction. During this process, the assembly chamber 30B forms a limit on the sliding portion 121 along the second direction Y. When the sliding portion 121 slides to the preset position or the limit position, the extension section 31 extends into the bayonet 121A, forming a limit to the switching mechanism 100.

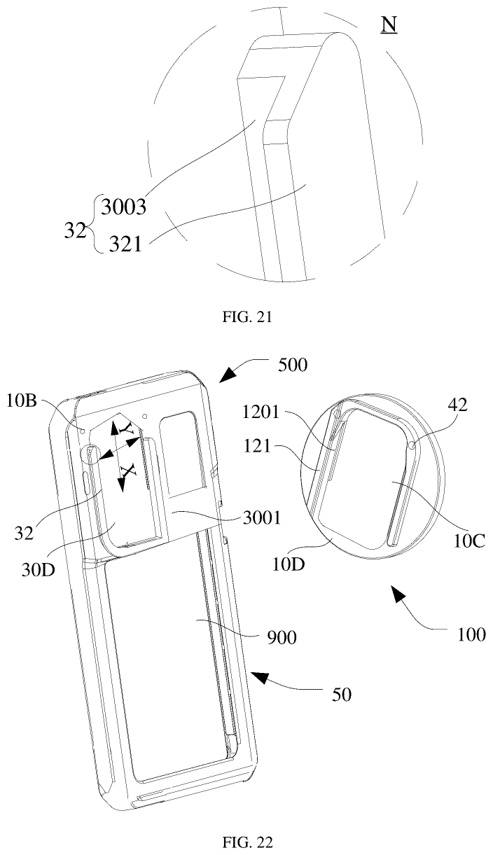

In an embodiment, the sliding portion 121 of the switching mechanism 100 can also be mounted by matching the sliding block with the slide groove. As shown in FIG. 21, the cooperation portion 32 includes a second ridge structure 321 provided at the edge of the avoidance hole 30D and extending in the first direction X, and the second ridge structure 321 is configured to limit the switching mechanism 100 in the second direction Y, so that when the switching mechanism 100 is mounted, the switching mechanism 100 can fit with the assembly mechanism 300 and slide along the first direction X to achieve mounting. The first ridge structure or the second ridge mechanism is respectively provided with a groove extending along the X direction or a protrusion matching the groove. When the switching mechanism 100 is mounted by sliding along the X direction, the switching mechanism 100 and the assembly mechanism 300 always maintain a sliding connection in the concave-convex fit. A more detailed description is provided below. Of course, the groove can also be provided on the second ridge, and the corresponding protrusion is provided on the first ridge.

In this embodiment, the mounting member 30 is integrated with the cage frame 50. The second ridge structure 321 can be regarded as a guide rail, and the second ridge structure 321 protrudes from the mounting member 30. When the switching mechanism 100 is mounted on the assembly mechanism 300, the second ridge 321 of the switching mechanism 300 is aligned with the slide groove 1201 and slides along the X direction. The second ridge structure 321 and the slide groove 1201 of the switching mechanism 100 slide in cooperation, so that the second ridge structure 321 and the sliding portion 121 can form the sliding structure in the concave-convex fit. Similarly, if the cooperation portion 32 is provided with the slide groove 1201, the sliding portion 121 is provided as a ridge structure, and the concave-convex fit sliding structure can also be formed. Therefore, the specific forms of the cooperation portion 32 and the sliding portion 121 are not completely limited to the forms shown in the drawings.

In an embodiment, as shown in FIG. 25, a second guide groove 3003 that is recessed inward is provided on the side of the second ridge structure 321 away from the avoidance hole 30D, and the extending direction of the second guide groove 3003 is consistent with the extending direction of the second ridge structure 321.

The second ridge structure 321 is formed with the second guide groove 3003 that is recessed inward, and at the same time, the sliding portion 121 is formed with a protruding block P cooperated with the second guide groove 3003 to form two sets of sliding structures in the concave-convex fit with the sliding portion 121; or the second ridge structure 321 is formed with a concave convex structure cooperated with the sliding portion 121 to limit.

In this embodiment, the second ridge structure 321 is formed with a second guide groove 3003 recessed inwardly, and the extending direction of the second guide groove 3003 is consistent with the extending direction of the slide groove 1201, so that the second ridge structure 321 and the sliding portion 121 form two sets of sliding structures in the concave-convex fit. The second guide groove 3003 is provided at the bottom of the second ridge structure 321, specifically, the second guide groove 3003 is formed between the second ridge structure 321 and the first assembly surface 10D. As shown in FIG. 25, the sliding portion 121 is also formed with a first guide groove 1202 recessed inwardly so as to form a protruding block P at the ends of the first guide groove 1202 and the first ridge structure 1203. In this way, the second limit structure and the sliding portion 121 form two sets of concave-convex fit structures, and the sliding of the switching mechanism 100 on the assembly mechanism 300 is more stable.

In this embodiment, the switching mechanism 100 includes the body 10, the sliding portion 121 and the positioning structure 123, and the lens hole 10A can be a circular hole or other polygonal hole, for example, the lens hole 10A can be a square hole, which is not specifically limited here. A filter is mounted at the lens hole 10A of the switching mechanism 100, so that the filter can play a filtering role.

The second direction Y can be perpendicular to the first direction X.

Referring to FIG. 17 to FIG. 21, the sliding portion 121 is provided with a slide groove 1201, and the cooperation portion 32 is ridge-shaped; or the sliding portion 121 is ridge-shaped, and the cooperation portion 32 is provided with a slide groove 1201 to form the sliding structure in the concave-convex fit.

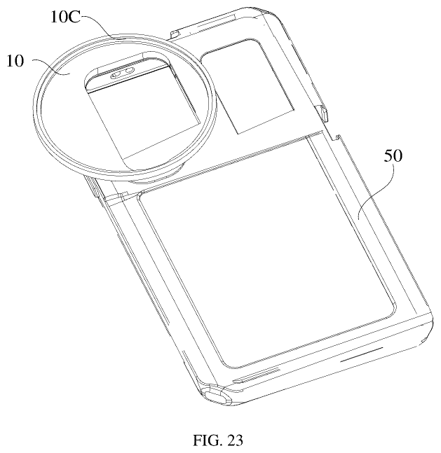

In an embodiment, the assembly of the switching mechanism 100 and the assembly mechanism 300 is shown in FIG. 22, FIG. 23, FIG. 25 and FIG. 26.

The second ridge structure 321 forms a limit on the switching mechanism 100 in the second direction Y, so that when the switching mechanism 100 moves to the preset position along the first direction X, the positioning component 40 and the positioning structure 123 are in the concave-convex fit to lock the switching mechanism 100.

The switching mechanism 100 moves to the preset position under the limit of the sliding portion 121, and the positioning structure 123 and the positioning component 40 are in the concave-convex fit, thereby locking the switching mechanism 100. Light transmitting holes of the mounted switching mechanism 100 and the assembly mechanism 300 are aligned, so that the light transmitting hole can face the filter mounted on the switching mechanism 100, ensuring the use effect of the filter.

The positioning component 40 and the positioning structure 123 are in the concave-convex fit to realize the positioning of the switching mechanism 100 at the preset position, and the positioning is more secure, so that during the use of the rabbit cage apparatus 500, the switching mechanism 100 is not easy to slip off and cause damage to the rabbit cage apparatus 500 or affect the use effect of the filter.

As shown in FIG. 17, the sliding portion 121 is provided on the switching mechanism 100, and the sliding portion 121 is configured to be in the concave-convex fit with the second ridge structure 321 on the assembly mechanism 300, so that the switching mechanism 100 is more stable when sliding along the first direction X. The concave-convex fit structure can better limit the switching mechanism 100 in the second direction Y, so that the sliding of the switching mechanism 100 can be mounted more smoothly.

The positioning component 40 can be provided on the top of the second ridge structure 321, and the positioning structure 123 is provided on the top of the sliding portion 121.

The positioning component 40 is integrated onto the second ridge structure 321, and the positioning structure 123 is integrated into the sliding portion 121. The sliding portion 121 is cooperated with the second ridge structure 321 to slide, so that the running track of the positioning structure 123 provided on the sliding portion 121 is more accurate. The positioning component 40 is one by one corresponding to the positioning structure 123, so that when the switching mechanism 100 runs to the preset position, the positioning structure 123 can position with the positioning component 40 more accurately.

Referring to FIG. 17, in an embodiment, the switching mechanism 100 is formed with a first assembly surface 10D around the lens hole 10A, and the sliding portion 121 protrudes and is provided on the first assembly surface 10D. Referring to FIG. 20, the assembly mechanism 300 is formed with a second assembly surface 3001 around the avoidance hole 30D, and the second ridge structure 321 protrudes and is provided on the second assembly surface 3001.

The side of the switching mechanism 100 configured for mounting with the assembly mechanism 300 is the first assembly surface 10D, and the sliding portion 121 can be provided around the lens hole 10A on the first assembly surface 10D, so that the sliding portion 121 can extend along the first direction X on the opposite sides of the lens hole 10A. The side of the assembly mechanism 300 configured for mounting with the switching mechanism 100 is the second assembly surface 3001. The second ridge structure 321 is provided around the avoidance hole 30D on the second assembly surface 3001, so that the second ridge structure 321 can extend along the first direction X on the opposite sides of the avoidance hole 30D. The positioning component 40 is provided on each side of the avoidance hole 30D.

The sliding portion 121 is provided on the opposite sides of the lens hole 10A, and the sliding portion 121 is the second ridge structure 321. The second ridge structure 321 is provided on the opposite sides of the avoidance hole 30D, and the second ridge structure 321 on the same side is cooperated with the sliding portion 121 to slide. Compared with the limit structure provided on a single side, the sliding process of the switching mechanism 100 is smoother.

In an embodiment, referring to FIG. 22, the switching mechanism 100 slides to the preset position, so that the sliding portion 121 and the second ridge structure 321 can form a closed ring structure.

In an embodiment, two first ridge structures 1203 are respectively formed on the edges of the opposite sides of the lens hole 10A, and a blocking bar 1205 is provided between the two first ridge structures 1203. The opposite ends of the blocking bar 1205 are respectively connected to the two first ridge structures 1203, so that a slide entrance T is formed at one end of the first ridge structure 1203 opposite to the blocking bar 1205.

The first ridge structure 1203 and the blocking bar 1205 form a roughly U-shaped structure, which is semi-opening. The first ridge structures 1203 on both sides are configured for sliding connection. The first ridge structures 1203 on both sides are connected through the blocking bar 1205. The blocking bar 1205 is directly faced with the opening T. After the opening T slides into the slide groove 1201, the blocking bar 1205 plays a role of shielding light. On the contrary, additional light shines in from the gap, which plays a role of improving light filtering.

Overall, as shown in FIG. 22, the sliding portion 121 is roughly U-shaped, and the second ridge structure 321 is also roughly U-shaped. The closed annular structure is provided around the lens hole 10A and the avoidance hole 30D, so that after the switching mechanism 100 is assembled in place, the second ridge structure 321 and the sliding portion 121 can form an annulus. The annular second ridge structure 321 and the sliding portion 121 can prevent light from leaking from the gap and improve the filtering effect of the filter.

As shown in FIG. 8 and FIG. 20, when the sliding portion 121 and the second ridge structure 321 slide together, the top surface of the sliding portion 121 is fitted with the second assembly surface 3001, and the top surface of the second ridge structure 321 is fitted with the first assembly surface 10D, so that the switching mechanism 100 runs more smoothly during the sliding assembly process.

More specifically, the second ridge structure 321 can slide on the outer sidewall of the sliding portion 121.

The concave-convex fit of the positioning component 40 and the positioning structure 123 is not limited to whether the positioning component 40 is a concave structure or a convex structure, and whether the positioning structure 123 is a convex structure or a concave structure, as long as the positioning component 40 and the positioning structure 123 can be in the concave-convex fit when the switching mechanism 100 slides to the preset position in the first direction X.

In an embodiment, the sliding portion 121 is provided with an L-shaped cross section, and a soft layer 60 is provided on both sides of the sliding portion 121. When the switching mechanism 100 is mounted on the assembly mechanism 300, the first assembly surface 10D of the switching mechanism 100 is fitted with the second assembly surface 3001 of the assembly mechanism 300. As shown in FIG. 22, the sliding portion 121 of the switching mechanism 100 slides along the assembly direction S in the second ridge structure 321 of the assembly mechanism 300, and the sliding portion 121 is engaged in the groove formed by the second ridge structure 321. Along the assembly direction S, the soft layer 60 is provided on the opposite sides of the sliding portion 121. The soft layer 60 can eliminate the gap between the sliding portion 121 and the second assembly surface 3001, so that the switching mechanism 100 is mounted more stably.

In this embodiment, the positioning component 40 is a round hole, and the positioning component 40 is provided in the assembly direction S.

The concave-convex fit of the sliding portion 121 and the second ridge structure 321 can have various forms, for example, a protrusion is provided in the second ridge structure 321 and a concave structure is provided on the sliding portion 121, or vice versa. The specific shapes of the protrusion and the concave structure is not specifically limited.

In this embodiment, the assembly of the switching mechanism 100 and the assembly mechanism 300 is shown in FIG. 23 and FIG. 25.

As shown in FIG. 17 and FIG. 26, the positioning component 40 is an elastic member, and the positioning structure 123 is a positioning groove.

In an embodiment, the assembly chamber 30B includes a pre-positioning chamber 301B and a clamping chamber 302B communicated with the pre-positioning chamber 301B. The extension section 31 is provided at the top of the clamping chamber 302B, and the opening 30A is provided at the top of the pre-positioning chamber 301B and communicated with the pre-positioning chamber 301B.

In this embodiment, the pre-positioning chamber 301B and the clamping chamber 302B are communicated along the first direction X. The clamping chamber 302B is provided inside the pre-positioning chamber 301B, The extension section 31 is provided inside the pre-positioning chamber 301B and at the top of the clamping chamber 302B, and the opening 30A is provided at the top of the pre-positioning chamber 301B and communicated with the pre-positioning chamber 301B.

The pre-positioning chamber 301B is configured to pre-mount the switching mechanism 100, and the clamping chamber 302B and the extension section 31 are configured to cooperate to limit the switching mechanism 100.

In this embodiment, as shown in FIG. 8, the extension section 31 is the sidewall of the assembly chamber 30B. When in use, one end of the sliding portion 121 of the switching mechanism 100 extends into the clamping chamber 302B along the Z direction, and slides to the limit position or preset position along the X direction, that is, the sliding portion 121 drives the bayonet 121A to slide until the bayonet 121A contacts and enters the extension section 31, the sliding portion 121 is assembled on the extension section 31 through the frictional force between the opening 1 and the extension section 31. At this time, the limit section 1212 is accommodated in the clamping chamber 302B, as shown in FIG. 11.

In this embodiment, referring to FIG. 6 to FIG. 11, the opening 30A is provided at the top of the pre-positioning chamber 301B along the third direction Z, and the opening 30A is connected to the pre-positioning chamber 301B. When assembling, the sliding portion 121 is inserted into the pre-positioning chamber 301B from the opening 30A along the Z direction. The assembly mechanism 300 is provided with an extension section 31 adjacent to the opening 30A, so that the clamping chamber 302B is provided at the bottom of the extension section 31 along the third direction Z, and the clamping chamber 302B is provided at one side of the pre-positioning chamber 301B along the first direction X. In addition, the thickness of the extension section 31 matches the width of the opening 30A of the bayonet 121A or the notch 121B, so that the bayonet 121A can be fixed by frictional force after being inserted into the extension section 31. The assembly chamber 30B is formed with a sliding cavity with a roughly L-shaped cross section through the communication among the opening 30A, the pre-positioning chamber 301B and the clamping chamber 302B. The communication between the opening 30A and the pre-positioning chamber 301B forms the vertical side of the L-shape, and the communication between the pre-positioning chamber 301B and the clamping chamber 302B forms the horizontal side of the L-shape.

The sliding portion 121 extends into the pre-positioning chamber 301B through the opening 30A along the third direction Z to pre-position the assembly position of the assembly mechanism 300 and the switching mechanism 100. The switching mechanism 100 slides along the first direction X so that one end of the sliding portion 121 extending into the assembly chamber 30B slides to be snapped in the clamping chamber 302B, and the end is limited in the third direction Z by the extension section 31 and is limited in the second direction Y by the two side walls of the clamping chamber 302B, thereby improving the assembly stability of the sliding portion 121 snapped in the assembly chamber 30B.

In an embodiment, the assembly mechanism 300 further includes a positioning component 40 or a positioning groove 10B, and the positioning component 40 or the positioning groove 10B is configured to position the switching mechanism 100. In this embodiment, the positioning component 40 or the positioning groove 10B is provided at intervals from the assembly chamber 30B, and the assembly chamber 30B and the positioning component 40 or the positioning groove 10B are configured to respectively mount and position the switching mechanism 100. The switching mechanism 100 moves along the first direction X under the limit of the sliding portion 121. When the moves to the preset position, the switching mechanism 100 can be locked by the positioning component 40 or the positioning groove 10B and the positioning structure 123, so as to prevent the switching mechanism 100 from moving to the preset position along the first direction X and then moving in the reverse direction and falling off, so as to facilitate the mounting of the switching mechanism 100. The assembly mechanism 300 also includes a mounting member 30, and the positioning component 40 is provided on the mounting member 30.

In an embodiment, referring to FIG. 8 and FIG. 13 and FIG. 17, the mounting member 30 is provided with an accommodation groove 30C, and the positioning component 40 includes: a positioning structure 123 and a positioning member 42. The positioning structure 123 is provided in the accommodation groove 30C. One end of the positioning structure 123 is connected to the bottom wall of the accommodation groove 30C, and the positioning member 42 is provided at the other end of the positioning structure 123. The positioning structure 123 is configured to drive the positioning member 42 to elastically abut the switching mechanism 100.

In this embodiment, along the extending direction of the first direction X, the assembly mechanism 300 is provided with an accommodation groove 30C spaced from the assembly chamber 30B; the switching mechanism 100 is provided with a positioning groove 10B spaced from the sliding portion 121; the positioning groove 10B is concavely provided on the side of the switching mechanism 100 facing the assembly mechanism 300 corresponding to the positioning component 40, and the positioning component 40 is provided in the accommodation groove 30C.

When the switching mechanism 100 slides relative to the assembly mechanism 300 and slides to the position where the positioning groove 10B is directly faced with the accommodation groove 30C, one end of the positioning component 40 pops out and is inserted into the positioning groove 10B to limit the sliding direction of the switching mechanism 100 and the assembly mechanism 300 along the first direction X. The sliding portion 121 and the positioning component 40 can fully limit the switching mechanism 100 and the assembly mechanism 300 along the first direction X, the second direction Y and the third direction Z, thereby improving the assembly reliability of the switching mechanism 100 and the assembly mechanism 300.

The mounting member 30 of the assembly mechanism 300 has a thickness along the third direction Z, so that the plane on one side of the mounting member 30 that is in contact with the switching mechanism 100 is recessed with the assembly chamber 30B, the accommodation groove 30C and the avoidance hole 30D. The switching mechanism 100 and the mounting member 30 are detachably assembled by sliding, so that the assembly mechanism 300 and the switching mechanism 100 can be detachably assembled or disassembled.

Referring to FIG. 10, FIG. 11, FIG. 13 and FIG. 14, the compression direction or the extending direction of the elastic member 41 is at an angle to the sliding direction of the switching mechanism 100 relative to the assembly mechanism 300. As shown in FIG. 11, in this embodiment, the switching mechanism 100 slides relative to the assembly mechanism 300 along the first direction, that is, the X direction to be assembled or slides in the opposite direction for disassembly. The compression direction or the extending direction of the positioning structure 123 is parallel to the third direction, that is, the Z direction. The two directions are set at an angle, and the angle can be a right angle, or an acute angle or an obtuse angle close to a right angle. The accommodation groove 30C is opened on the side of the mounting member 30 of the assembly mechanism 300 facing the switching mechanism 100, that is, the rabbet of the accommodation groove 30C is provided towards the third direction Z. One end of the positioning structure 123 along the third direction Z is connected to the bottom wall of the accommodation groove 30C, and the positioning member 42 is relatively provided at the other end of the positioning structure 123 along the third direction Z, so as to drive the positioning member 42 to be snapped in the positioning groove 10B through the elastic energy storage and energy release of the positioning structure 123.

As shown in FIG. 14 and FIG. 26, the positioning structure 123 is an elastic member 41, the positioning member 42 can be a round bead, and the opening 30A of the accommodation groove 30C is smaller than the diameter of the round bead, so that the round bead can partially extend out of the rabbet of the accommodation groove 30C under the push of the positioning structure 123 without completely falling out of the accommodation groove 30C. The elastic member 41 can also be a component made of elastic material, so that the elastic member 41 itself has elasticity. Similarly, when the switching mechanism 100 slides on the assembly mechanism 300, the elastic member 41 can also be retracted into the accommodation groove 30C due to the extrusion.

The positioning member 42 can be a positioning column or a positioning bead. The positioning member 42 be provided with an arc-shaped top surface or an inclined side surface. The positioning groove 10B is an arc-shaped or a conical inner concave surface. The inner concave surface of the positioning groove 10B is matched with the contact surface of the positioning column or the positioning bead to improve the tightness of locking and positioning of the switching mechanism 100 and the assembly mechanism 300. The matching surface of the positioning member 42 and the positioning groove can be a curved surface. On the one hand, the curved surface has a guiding function, which can guide the positioning member 42 to gradually slide into the positioning groove 10B. In the process of the positioning member 42 to be cooperated with the positioning groove, the curved surface can be relatively smooth without being stuck, and vibration to the switching mechanism 100 can be avoided. For example, the positioning member 42 may be a spherical structure, a cylindrical structure, or a cylindrical structure with an inclined surface on the side.

In addition, a guide groove may be provided at the edge of the positioning groove 10B so that the positioning member 42 can be more easily inserted into the positioning groove. When the switching mechanism 100 is pushed in the reverse direction, the positioning member 42 can be easily separated from the positioning groove. For example, when the switching mechanism 100 needs to be disassembled for replacement, the switching mechanism 100 needs to be pushed in the reverse direction so that the switching mechanism 100 can be separated from the assembly mechanism 300.

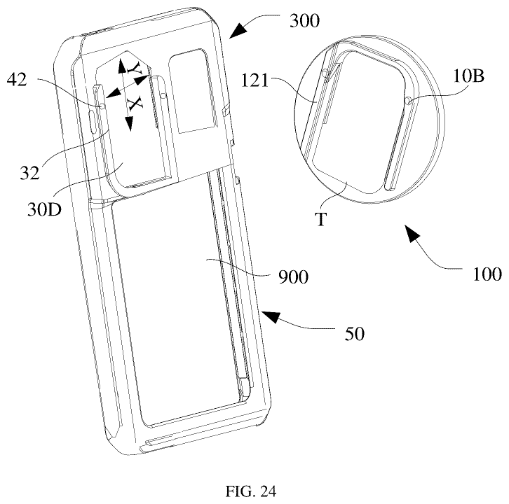

In other embodiments, the positioning component 40 may be provided on the first ridge structure 1203 or the first assembly surface 10D, and may be provided at any position on the first ridge structure 1203, for example, may be provided on the front or side, inside or outside of the first ridge structure 1203. Similarly, the position of the positioning groove 10B to be cooperated with the positioning component 40 is also provided at a corresponding position of the assembly mechanism 300 according to the position of the positioning component 40. The positioning component 40 may also adopt a snap-fitting or block method. When the switching mechanism 100 is slidably mounted to a specific position or the limit position on the switching mechanism 300, the switching mechanism 100 is positioned on the switching mechanism 300 through the snap-fitting or block method. As shown in FIG. 22, the positioning component 40 can be a positioning ball, and the positioning component 40 can be provided on the switching mechanism 100. As shown in FIG. 24, the positioning component 40 can also be provided on the assembly mechanism 300, and the corresponding positioning groove 10B is provided on the switching mechanism 100. In summary, the positions of the positioning component 40 and the positioning groove 10B on the switching mechanism 100 or the assembly mechanism 300 are interchangeable, and the same positioning function can be achieved when the switching mechanism 100 and the assembly mechanism 300 are mounted. In other embodiments, the positioning component 40 can also be provided at the position of the first ridge structure 1203, and the corresponding positioning groove 10B is provided on the switching mechanism 100. In addition to being on the front of the first ridge structure 1203, the positioning component 40 can also be provided on the side of the first ridge structure 1203.

The positioning component mentioned above can also be an integral component including a spring and a round bead or a cylinder and a sleeve for accommodating the spring and the round bead, and the integral component is directly mounted on the assembly mechanism 300 or the accommodation groove 30C on the switching mechanism 100.

In an embodiment, as shown in FIG. 27, the present application provides a switching mechanism 100, including a lens hole 10A or a filter installation area, and a second soft layer 777 is provided at the edge of the lens hole 10A or the edge of the filter installation area. When the filter is installed in the lens hole 10A or the filter installation area, the second soft layer 777 is located between the filter and the switching mechanism 100. After the filter is installed, the frame of the filter and the second soft layer 777 are abutted against each other, and the second soft layer 777 is deformed. On the one hand, the gap between the filter frame and the switching mechanism can be blocked to prevent light outside the filter from entering the lens through the gap; on the other hand, the filter can also be prevented from loosening and not fitting tightly due to the increase of the gap or the increase of the error caused by wear or careless installation by the user. The material of the soft layer includes at least one of foam, rubber, and silicone. The soft layer can also be replaced by other elastic structures.

The present application also provides a rabbit cage apparatus 500. As shown in FIG. 8 and FIG. 23, the rabbit cage apparatus 500 includes: a cage frame 50, an assembly mechanism 300, and a switching mechanism 100. The assembly mechanism 300 is provided on the cage frame 50, and the switching mechanism 100 is detachably assembled with the assembly mechanism 300 through a disassembly structure 12.

The cage frame 50 is formed with a frame 11, the cage frame 50 is provided with a mounting position 50B, and the assembly mechanism 300 is detachably connected to the mounting position 50B. Specifically, the cage frame 50 is provided with a mounting hole 50C on the periphery adjacent to the mounting position 50B, and the assembly mechanism 300 is provided with a fixed hole 30E. The rabbit cage apparatus 500 also includes a fastener 51, and the fastener 51 is configured to pass through the fixed hole 30E and is connected with the mounting hole 50C through threads. In other embodiments, the assembly mechanism 300 and the cage frame 50 can also be integrated or fixed by welding buckles.

In this embodiment, the mounting position 50B of the cage frame 50 corresponds to the position of the camera module of the terminal device. At least one mounting hole 50C is opened on the periphery of both sides of the cage frame 50 adjacent to the mounting position 50B, and the fixed holes 30E are provided on both sides of the mounting member 30 of the assembly mechanism 300 corresponding to the mounting hole 50C. The end of the fixed hole 30E facing away from the cage frame 50 is recessed to form a protective groove for avoiding one end of the fastener 51. The fixed hole 30E can be a through hole, the mounting hole 50C is a thread hole, and the fastener 51 can be a screw or a bolt. The protective groove is configured to recess and protect the nut of the screw or bolt, and can be a countersunk hole to prevent the nut from protruding from the surface of the mounting member 30, which can prevent scratches and prevent the screw or bolt from loosening due to long-term accidental touch, thereby improving the reliability of the detachable connection between the mounting member 30 and the cage frame 50.

In an embodiment, referring to FIG. 5, FIG. 8 and FIG. 16, the rabbit cage apparatus 500 also includes a soft layer 60 provided on the assembly mechanism 300 or the switching mechanism 100. When the assembly mechanism 300 and the switching mechanism 100 are assembled, the soft layer 60 is provided between the switching mechanism 100 and the assembly mechanism 300.

Considering that there is a gap between the switching mechanism 100 and the assembly mechanism 300 during assembly, the soft layer 60 is provided on the first assembly surface 10D to compensate for the gap, so that the switching mechanism 100 is mounted more firmly without displacement.

In this embodiment, the soft layer 60 is provided on the assembly mechanism 300, or the soft layer 60 is provided on the switching mechanism 100, so that when the switching mechanism 100 is mounted on the assembly mechanism 300, the soft layer 60 is sandwiched between the assembly mechanism and the switching mechanism 100. The soft layer 60 can be a rubber layer, a silicone layer, a fiber layer, a cloth layer, a foam layer or a combination thereof, or can be other flexible soft pads. After assembly, the soft layer 60 is provided between the switching mechanism 100 and the assembly mechanism 300 to compensate for the gap between the body 10 and the mounting member 30, improve the assembly compactness of the switching mechanism 100 and the assembly mechanism 300, and increase the frictional force of the switching mechanism 100 and the assembly mechanism 300 along the O-XY plane, so as to prevent the switching mechanism 100 from returning in the opposite direction or loosening along the sliding direction, thereby ensuring the reliable assembly.

As shown in FIG. 7, FIG. 8, FIG. 13, FIG. 14 and FIG. 23, the assembly mechanism 300 of the rabbit cage apparatus 500 is an overall frame structure, the mobile phone is detachably mounted on the rabbit cage apparatus 500, and the avoidance hole 30D of the assembly mechanism 300 and the lens hole 10A of the switching mechanism 100 constitute the light transmitting hole of the filter component. When shooting on the mobile phone, the mobile phone is mounted on the rabbit cage apparatus 500, and the switching mechanism 100 is slidably mounted on the assembly mechanism 300. When the switching mechanism 100 is mounted in place, the lens hole 10A is aligned with the avoidance hole 30D, the positioning structure 123 and the positioning component 40 are in the concave-convex fit, so that the switching mechanism 100 can be mounted more firmly. Finally, the filter is mounted on the switching mechanism 100 so that the filter covers the lens hole 10A, and the shooting effect of the camera device can be obtained.

In an embodiment, the switching mechanism and the assembly mechanism are generally in the form of a plate-shape structure, and the material of which may be metal, plastic, fiber, wood, or a combination thereof.

It is obvious that the above embodiments are merely examples for clear illustration and are not intended limit the present application.

For those skilled in the art, other changes of different forms can be made on the basis of the above description, which is not necessary and cannot be all listed here. Any apparent change or alteration resulting therefrom remains within the scope of the present application.

What is claimed is:

1. A switching mechanism applied to being assembled with an assembly mechanism, comprising:
a body provided with a lens hole, wherein the lens hole is configured for mounting a filter; and
at least one disassembly structure provided on the body, wherein the disassembly structure comprises a sliding portion configured to be detachably and slidably connected to the assembly mechanism.

2. The switching mechanism of claim 1, wherein the sliding portion is in a concave and convex fit with the assembly mechanism, so as to be detachably and slidably connected to the assembly mechanism.

3. The switching mechanism of claim 1, wherein the sliding portion is provided with a bayonet configured to be clamped with the assembly mechanism.

4. The switching mechanism of claim 3, wherein the sliding portion comprises:
a connection section, wherein one end of the connection section is connected to the body; and
a limit section provided at the other end of the connection section, wherein the connection section, the limit section and the body are enclosed to form the bayonet.

5. The switching mechanism of claim 1, further comprising:
a soft layer, wherein the soft layer is sandwiched between the switching mechanism and the assembly mechanism after the switching mechanism is assembled with the assembly mechanism.

6. The switching mechanism of claim 2, wherein the sliding portion comprises a first ridge structure extending in a first direction, and the first ridge structure is configured to limit the switching mechanism in a second direction; the first ridge structure is a sliding guide component, and the second direction is intersected with the first direction.

7. The switching mechanism of claim 6, wherein the first ridge structure is formed with a first guide groove recessed inward or outward.

8. The switching mechanism of claim 1, wherein the disassembly structure is provided with at least one positioning structure, and the positioning structure is cooperated and positioned with the assembly mechanism.

9. The switching mechanism of claim 8, wherein the positioning structure is a positioning member configured to retract and protrude, or the positioning structure is a positioning groove.

10. The switching mechanism of claim 6, wherein two first ridge structures are respectively formed on edges of opposite sides of the lens hole; a blocking bar is provided between the two first ridge structures, and opposite ends of the blocking bar are correspondingly connected to the two first ridge structures, so that a slide entrance is formed at an end of the first ridge structure opposite to the blocking bar.

11. An assembly mechanism applied to mounting a switching mechanism, comprising:
a mounting member provided with an avoidance hole, wherein an area of the mounting member without the avoidance hole is provided with a cooperation portion cooperated and limited with the sliding portion of the switching mechanism of claim 1.

12. The assembly mechanism of claim 11, wherein the cooperation portion is in a concave and convex fit with the switching mechanism, so as to be detachably and slidably connected to the switching mechanism.

13. The assembly mechanism of claim 11, wherein the mounting member is provided with an assembly chamber with an opening, and the assembly chamber is configured to slidably cooperate with the sliding portion of the switching mechanism; a section is provided at an edge of the assembly chamber, and the section is configured to be snapped into the bayonet of the switching mechanism.

14. The assembly mechanism of claim 13, wherein the assembly chamber comprises a pre-positioning chamber and a clamping chamber communicated with the pre-positioning chamber; the section is provided at the clamping chamber, and the opening is provided at the pre-positioning chamber and communicated with the pre-positioning chamber.

15. The assembly mechanism of claim 11, further comprising:
a positioning component configured to position the switching mechanism.

16. The assembly mechanism of claim 11, further comprising:
a positioning component, wherein the mounting member is provided with an accommodation groove, and the positioning component comprises:
an elastic member provided in the accommodation groove; and
a positioning member, wherein the elastic member is configured to drive the positioning member to elastically abut against the switching mechanism.

17. The assembly mechanism of claim 12, wherein the cooperation portion comprises a second ridge structure provided on at least one side of the avoidance hole and extended in a first direction; the second ridge structure is configured to limit the switching mechanism in a second direction, so that the switching mechanism is configured to slide along the first direction.

18. The assembly mechanism of claim 17, wherein a second guide groove recessed is provided on the second ridge structure, and an extending direction of the second guide groove is consistent with an extending direction of the second ridge structure.

19. The assembly mechanism of claim 11, further comprising:
a soft layer, wherein the soft layer is sandwiched between the switching mechanism and the assembly mechanism after the switching mechanism is assembled with the assembly mechanism.

20. A rabbit cage apparatus, comprising:
a cage frame;
an assembly mechanism provided at the cage frame;
a switching mechanism detachably assembled with the assembly mechanism through a disassembly structure; and
a soft layer;
wherein the soft layer is sandwiched between the switching mechanism and the assembly mechanism after the assembly mechanism is assembled with the switching mechanism.
